(19) United States
(12) Patent Application Publication
(10) Pub. No.: US 2026/0306358 A1
(43) Pub. Date: Oct. 8, 2026

(54) DEVICES AND SYSTEMS FOR THERMAL MANAGEMENT AND INGRESS PROTECTION OF MEDICAL DEVICES

(71) Applicant: ZOLL Circulation, Inc., San Jose, CA (US)

(72) Inventors: Ari Manoukian, Mountain View, CA (US); Byron J. Reynolds, Gilroy, CA (US)

(73) Assignee: ZOLL Circulation, Inc., San Jose, CA (US)

(21) Appl. No.: 19/474,909

(22) PCT Filed: Apr. 12, 2024
(86) PCT No.: PCT/US2024/024337

§ 371 Date: Oct. 13, 2025

Related U.S. Application Data
(60) Provisional application No. 63/496,238, filed on Apr. 14, 2023.

(51) Int. Cl. A61H 31/00; H02K 9/14

(52) U.S. Cl. CPC A61H 31/006; A61H 31/008; H02K 9/14

(57) ABSTRACT

A system for performing chest compressions on a patient includes an actuation assembly, a platform configured to support the patient, and at least one baffle. The platform encloses the actuation assembly. The platform defines intake and exhaust apertures. The at least one baffle is disposed at the intake aperture or the exhaust aperture. The baffle may include a channel in communication with the intake aperture or the exhaust aperture, a groove formed around a perimeter of the baffle, and a cover disposed over the channel. The cover is configured to deflect liquid towards the groove and away from the channel. The groove is configured such that liquid directed towards the groove flows out of the at least one baffle.

### TECHNICAL FIELD

The present disclosure relates generally to a baffle for use with medical devices for thermal management and liquid ingress protection.

### BACKGROUND

One of the challenges in building a lightweight, compact electro-mechanical medical devices such as an electro-mechanical chest compression device is thermal management of the components that generate heat such as, e.g., a motor, a brake assembly, controller, etc. Overheating of such components could damage the compact electro-mechanical medical devices or reduce run time of such devices. Further, overheating of such components may injure a patient.

Another aspect of thermal management involves liquid ingress protection. In order to provide a barrier against the entry of fluids, intake and exhaust apertures of the electro-mechanical medical devices may be covered with a multi-layer mesh filter. For example, the filter may include layers including a plurality of hydrophobic mesh layers. However, while a mesh filter having a plurality of layers may provide some liquid ingress protection, such a configuration significantly reduces airflow. Airflow through such a configuration is further reduced when the mesh filter is exposed to debris or dust that clog the openings in the filter.

Accordingly, there is a continuing need for devices and methods for improving performance of cooling lightweight and compact electro-mechanical medical devices, while providing liquid ingress protection.

### SUMMARY

In accordance with an aspect of the present disclosure, there is provided a system for performing chest compressions on a patient. The system includes an actuation assembly and at least one baffle. The actuation assembly is configured to provide chest compressions on the patient. The system may include a platform configured to support the patient during chest compressions. The platform may enclose the actuation assembly. The system, platform or actuation assembly defines at least one aperture. The at least one aperture may be configured for providing the actuation assembly with airflow. The at least one baffle is disposed at the at least one aperture. The at least one baffle includes a channel in communication with the at least one aperture, a groove formed around at least a portion of a perimeter of the at least one baffle or channel, and a cover disposed over the channel. The cover may be configured to deflect liquid towards the groove. The groove may be configured to direct liquid out of the at least one baffle. The groove and the cover may provide protection against liquid ingress into the channel while allowing airflow into the channel.

In accordance with an aspect of the present disclosure, there is provided a system for performing chest compressions on a patient. The system includes an actuation assembly, a platform, and at least one baffle. The actuation assembly is configured to provide chest compressions on the patient. The platform is configured to support the patient during chest compressions. The platform encloses the actuation assembly. The platform defines an intake aperture configured for intake of cooling airflow and an exhaust aperture configured for exhaust of cooling airflow. The at least one baffle is disposed at the intake aperture or the exhaust aperture. The at least one baffle includes a channel in communication with the intake aperture or the exhaust aperture, a groove formed around a perimeter of the at least one baffle, and a cover disposed over the channel and configured to deflect liquid towards the groove. The groove is configured to direct liquid out of the at least one baffle. The groove and the cover provide protection against liquid ingress into the channel while allowing airflow into the channel. The groove may be formed around at least a portion of the perimeter of the at least one baffle.

In an embodiment, the groove may be configured to direct liquid out of the at least one baffle by gravity. The groove may be configured to direct liquid out of the at least one baffle by gravity based on the orientation of the system, platform or actuator assembly when in use.

In another embodiment, the groove may define a loop including a superior portion and an inferior portion such that liquid received in the loop flows towards the inferior portion and out of the at least one baffle by gravity.

In yet another embodiment, the at least one baffle may further include a lip configured to inhibit flow of liquid into the channel.

In yet another embodiment, the lip may extend towards the groove.

In still yet another embodiment, the lip and the cover may define a gap therebetween to allow airflow into the channel.

In still yet another embodiment, the at least one baffle may include a flared portion configured to facilitate flow of liquid out of the groove of the at least one baffle.

In still yet another embodiment, the cover may include a deflected portion extending into the groove.

In still yet another embodiment, the deflected portion may have an arcuate profile.

In an embodiment, the cover may define a concavity.

In another embodiment, the cover may be spaced apart from an opening of the channel by at least one support.

In yet another embodiment, the channel may define a longitudinal axis. The lip may be transverse to the longitudinal axis.

In still yet another embodiment, the at least one baffle may be formed of a hydrophobic material.

In still yet another embodiment, the at least one baffle may be molded as a single construct.

In still yet another embodiment, the at least one baffle may be monolithically formed as a single construct.

In still yet another embodiment, the at least one baffle may have a seal hermetically sealing against the first and second halves of the platform.

In still yet another embodiment, the groove may have a U-shaped cross-section.

In an embodiment, the system may further include a fan disposed within the platform. The fan may be arranged to draw air through the intake aperture and force air out of the exhaust aperture of the platform.

In an embodiment, the actuation assembly may include a motor, and the airflow acts to cool the motor. The system or actuation assembly may comprise a drive train. The drive train may be operatively coupled to the motor.

In another embodiment, the system may further include an actuator configured to provide compression and/or decompression on a patient.

In yet another embodiment, the actuator may be a belt or a piston. The drive train may be configured for attachment to the belt.

In still yet another embodiment, the cooling may be performed by natural convection cooling.

In still yet another embodiment, the at least one baffle may be configured to enable air to flow through the intake aperture or the exhaust aperture, while inhibiting flow of liquid into the platform.

The at least one baffle may include an inner wall, an outer wall spaced outwardly from the inner wall, a base wall connecting the inner and outer walls and thereby defining a groove around the perimeter of the at least one baffle.

In accordance with yet another aspect of the present disclosure, there is provided a system for performing chest compressions on a patient. The system includes a belt for compressing a chest of the patient, a motor, a drive train, a platform for housing the motor and the drive train, and at least one baffle. The drive train is operatively coupled to the motor. The drive train is configured for attachment to the belt. The platform is configured to support the patient during chest compressions. The platform defines an intake aperture for intake of cooling airflow and an exhaust aperture for exhaust of cooling airflow. At least one baffle is disposed at the intake aperture or the exhaust aperture to enable air to flow through the intake aperture or the exhaust aperture, while inhibiting flow of liquid into the platform. The at least one baffle includes an inner wall, an outer wall spaced outwardly from the inner wall, a base wall connecting the inner and outer walls and thereby defining a groove around a perimeter of the at least one baffle, a channel defined by the inner wall and in communication with the intake aperture or the exhaust aperture to enable airflow therethrough, and a cover supported over the channel and configured to deflect the liquid towards the groove such that liquid flows out of the at least one baffle through the groove, while enabling airflow through the channel. The groove may be defined around at least a portion of the perimeter of the at least on baffle.

In an embodiment, the at least one baffle may further include a lip extending outwardly from the inner wall. The lip may be configured to deter liquid from flowing into the channel.

In another embodiment, the lip may define an obtuse angle with respect to the inner wall.

In yet another embodiment, the cover may be disposed about the outer wall.

In still yet another embodiment, the cover may include a deflected portion extending towards the base wall.

In still yet another embodiment, the deflected portion may have an arcuate profile.

In still yet another embodiment, the inner wall may define an acute angle with respect to the base wall.

In still yet another embodiment, the cover may be secured to the inner wall by a support.

In still yet another embodiment, the channel may define a longitudinal axis. The inner wall may define an acute angle with respect to the longitudinal axis. In still yet another embodiment, the cover may have an arcuate profile.

In still yet another embodiment, the base wall, the inner wall, and the outer wall may have a U-shaped cross-section.

In an embodiment, the at least one baffle may include a flared portion extending outwardly from the outer wall to facilitate flow of liquid out of the at least one baffle.

In another embodiment, the at least one baffle may be disposed on the platform such that the base wall defines a plane extending in an anterior-posterior direction.

In yet another embodiment, the at least one baffle may be disposed on the platform such that liquid directed towards the base wall is guided out of the at least one baffle by gravity when the patient is supported by the platform.

In yet another embodiment, the at least one baffle may be formed of a hydrophobic material.

In still yet another embodiment, the at least one baffle may be molded as a single construct.

In still yet another embodiment, the at least one baffle may be monolithically formed as a single construct.

In still yet another embodiment, the at least one baffle may have a seal hermetically sealing against first and second halves of the platform.

In still yet another embodiment, the system may further include a fan arranged within the platform to draw air through the intake aperture and force air out of the exhaust aperture to effect forced air cooling of the motor.

In accordance with yet another aspect of the present disclosure, there is provided a medical device providing liquid ingress protection and forced air cooling of a motor. The medical device includes a motor, a housing, and at least one baffle. The motor is configured to effect at least a first function of the medical device. The motor generates heat while effecting the first function of the medical device. The housing is configured to enclose the motor therein. The at least one baffle is mounted on the housing to provide protection against liquid ingress into the housing while allowing airflow into or out of the housing to thereby cool the motor. The at least one baffle may include a liquid ingress protection rating of at least IPX4 and may have a heat dissipation requirement of at least 100 Watts. The IPX ratings recited herein may be in accordance with international standard IEC 60529. The motor may be configured to generate at least 100 Watts of heat while effecting the first function of the medical device.

In an embodiment, the medical device may include a mechanical chest compression device.

In another embodiment, the medical device may include a fan to draw air into the housing and force air out of the housing.

In yet another embodiment, the housing may include an intake aperture and an exhaust aperture in communication with the motor. The at least one baffle may be associated with the intake aperture or the exhaust aperture.

In still yet another embodiment, the motor may have an average power output of about 700-1000 Watts.

In still yet another embodiment, the at least one baffle may include a channel in communication with the intake aperture or the exhaust aperture, a groove formed around a perimeter of the at least one baffle, and a cover disposed over the channel and configured to deflect liquid towards the groove. The groove may be configured to direct liquid out of the at least one baffle.

In still yet another embodiment, the groove may be configured to direct liquid out of the at least one baffle by gravity.

In still yet another embodiment, the groove may define a loop including a superior portion and an inferior portion such that liquid received in the loop flows towards the inferior portion and out of the at least one baffle by gravity.

In still yet another embodiment, the at least one baffle may further include a lip configured to inhibit flow of liquid into the channel.

In still yet another embodiment, the lip may extend towards the groove.

In still yet another embodiment, the lip and the cover may define a gap therebetween to allow airflow into the channel.

In an embodiment, the at least one baffle may include a flared portion configured to facilitate flow of liquid out of the groove of the at least one baffle.

In another embodiment, the at least one baffle may be formed of a hydrophobic material.

In yet another embodiment, the at least one baffle may be molded as a single construct.

In still yet another embodiment, the at least one baffle may be monolithically formed as a single construct.

In still yet another embodiment, the at least one baffle may include a liquid ingress protection rating of IPX4.

In still yet another embodiment, the at least one baffle may include a liquid ingress protection rating of IPX4, IPX5, or IPX6.

In still yet another embodiment, the heat dissipation requirement of the at least one baffle may be in the range between 100 and 300 Watts.

In still yet another embodiment, the at least one baffle may have the liquid ingress protection rating of IPX4 and the heat dissipation requirement of about 300 Watts.

In still yet another embodiment, the medical device may further include a platform configured to support a patient thereon.

In still yet another embodiment, the medical device may further include an actuation assembly configured to provide compression and decompression on a patient.

In still yet another embodiment, the medical device may further include an actuator configured to provide compression and/or decompression on a patient.

In still yet another embodiment, the actuator may be a belt or a piston.

It will be appreciated that an embodiment described in relation to one aspect of the disclosure may be provided in combination with a different aspect or embodiment. The details of one or more embodiments are set forth in the accompanying drawings and the description below. Other features and advantages will be apparent from the description and drawings, and from the claims.

### BRIEF DESCRIPTION OF THE DRAWINGS

The accompanying drawings, which are incorporated in and constitute a part of the specification, illustrate one or more embodiments and, together with the description, explain these embodiments. The above and other aspects and features of this disclosure will become more apparent in view of the following detailed description when taken in conjunction with the accompanying drawings wherein like reference numerals identify similar or identical elements. The devices disclosed herein are described in detail with reference to the drawings, in which like reference numerals designate identical or corresponding elements in each of the several views. The terms parallel and perpendicular are understood to include relative configurations that are substantially parallel and substantially perpendicular up to about + or −10 degrees from true parallel and true perpendicular. Further, to the extent consistent, any or all of the aspects detailed herein may be used in conjunction with any or all of the other aspects detailed herein. The accompanying drawings have not necessarily been drawn to scale. Any values dimensions illustrated in the accompanying graphs and figures are for illustration purposes only and may or may not represent actual or preferred values or dimensions. Where applicable, some or all features may not be illustrated to assist in the description of underlying features.

FIG. 1A is a perspective view of a chest compression device in accordance with an embodiment of the present disclosure.

FIG. 1B is a perspective view of the chest compression device of FIG. 1A, illustrating use on a patient.

FIG. 2 is a top view of the chest compression device of FIG. 1A with a first half of a housing removed.

FIG. 3 is an enlarged view of the indicated area of detail of FIG. 2.

FIG. 4 is a partial perspective view of the chest compression device of FIG. 1A, illustrating a baffle in accordance with an embodiment of the present disclosure.

FIG. 5 is a partial perspective view of the chest compression device of FIG. 1A, illustrating a cross-section thereof.

FIGS. 6 and 7A are perspective views of the baffle of FIG. 4.

FIG. 7B is a perspective view of the baffle of FIG. 4 with a cover of the baffle removed.

FIG. 8 is a top view of the baffle of FIG. 7.

FIG. 9 is a front view of the baffle of FIG. 7.

FIG. 10 is a cross-sectional view of the baffle cut along section line “A-A” of FIG. 9.

FIG. 11 is a cross-sectional view of the baffle cut along section line “B-B” of FIG. 9.

FIG. 12 is a transparent perspective view of the baffle of FIG. 9.

FIG. 13 is a front view of the baffle of FIG. 9, illustrating flow of liquid.

FIG. 14 is a cross-sectional view of the baffle of FIG. 10, illustrating flow of liquid.

FIG. 15 is a cross-sectional view of the baffle of FIG. 10, illustrating airflow path.

FIG. 16 is a cross-sectional view of the baffle of FIG. 11, illustrating airflow path.

FIG. 17 is a cross-sectional view of a baffle for use with the chest compression device of FIG. 1A in accordance with another embodiment of the present disclosure.

FIG. 18 is a perspective view of the housing of the chest compression device of FIG. 1A, illustrating first and second halves of the housing separated from each other with the baffles mounted on the first housing half.

FIG. 19 is a perspective view of the first half of the housing of FIG. 18.

FIG. 20 is a partial perspective view of the first half of the housing of FIG. 18 with the baffle removed from the housing.

FIGS. 21-24 are perspective views of the baffle of FIG. 7 illustrating testing of liquid ingress protection.

FIGS. 25-27 are partial perspective views of the chest compression device of FIG. 1A, illustrating testing of liquid and solid ingress protection.

FIG. 28 is a perspective view of another chest compression device for use with the baffle of FIG. 7.

FIG. 29 is a front view of the chest compression device of FIG. 28.

### DETAILED DESCRIPTION

The description set forth below in connection with the appended drawings is intended to be a description of various, illustrative embodiments of the disclosed subject matter. Specific features and functionalities are described in connection with each illustrative embodiment; however, it will be apparent to those skilled in the art that the disclosed embodiments may be practiced without each of those specific features and functionalities.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. Further, it is intended that embodiments of the disclosed subject matter cover modifications and variations thereof.

It must be noted that, as used in the specification and the appended claims, the singular forms “a,” “an,” and “the” include plural referents unless the context expressly dictates otherwise. That is, unless expressly specified otherwise, as used herein the words “a,” “an,” “the,” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Furthermore, the terms “approximately,” “about,” “proximate,” “minor variation,” and similar terms generally refer to ranges that include the identified value within a margin of 20%, 10% or preferably 5% in certain embodiments, and any values therebetween.

All of the functionalities described in connection with one embodiment are intended to be applicable to the additional embodiments described below except where expressly stated or where the feature or function is incompatible with the additional embodiments. For example, where a given feature or function is expressly described in connection with one embodiment but not expressly mentioned in connection with an alternative embodiment, it should be understood that the inventors intend that that feature or function may be deployed, utilized or implemented in connection with the alternative embodiment unless the feature or function is incompatible with the alternative embodiment.

Cardiopulmonary resuscitation (CPR) is a valuable method of first aid used to resuscitate people who have suffered from cardiac arrest. CPR requires repetitive chest compressions to squeeze the heart and the thoracic cavity to pump blood through the body. In efforts to provide better blood flow and increase the effectiveness of resuscitation efforts, various mechanical devices have been proposed for performing CPR. In one type of mechanical chest compression device, a belt is placed around the patient's chest and the belt is used to effect chest compressions. Exemplary belt-based chest compression device includes AUTOPULSE® manufactured by ZOLL Circulation. Reference may be made to U.S. Pat. No. 10,639,234 and U.S. Patent Application Publication No. 2021/0093506, the entire disclosure of each of which is incorporated herein by reference, for a detailed discussion of a belt-based chest compression device.

In order to increase cardiopulmonary circulation induced by chest compression, a technique referred to as active compression-decompression (ACD) may be utilized. During the compression phase, a contact portion is pressed against the anterior surface of the patient as with standard chest compressions. Unlike standard chest compressions where the chest passively returns to its neutral position during the release phase, with ACD, the contact portion actively pulls upward during release or decompression phase. This active pulling upward, or active decompression, increases the release velocity and results in increased negative intrathoracic pressure, as compared to standard chest compressions, and induces enhanced venous blood to flow into the heart and lungs from the peripheral venous vasculature of the patient. In particular, during ACD chest compression-decompression, the anterior surface of the patient such as patient's sternum is typically pulled upward, beyond the neutral position of the sternum during the decompression phase, where “neutral” position is defined as the steady-state position of the sternum when no force—either upward or downward—is applied. Reference may be made to U.S. Patent Publication No. 2020/0121552 and Provisional Application No. 63/493,497, the entire disclosure of each of which is incorporated herein by reference, for a detailed discussion of an example of an ACD chest compression device. Yet another type of mechanical chest compression device includes a piston-based chest compression device, which applies compressions with the piston as described in more detail below. Another type of mechanical chest compression device includes a piston-based chest compression device with a belt drive. Such a hybrid chest compression device includes a backboard with a motor and a drive spool housed within the backboard, and a piston support frame secured to the backboard forming a patient channel between the piston support frame and the backboard. A belt is operably secured to the drive spool and enclosed within the backboard and the piston support frame and a piston is operably housed within the piston support frame. Actuation of the motor results in cyclic rotation and counter-rotation of the motor and corresponding winding and unwinding of the belt on the drive spool to effectuate cyclic extension and retraction of the piston against the patient's chest to perform mechanical cardiopulmonary resuscitation. Reference may be made to U.S. Pat. No. 9,211,229, the entire disclosure of which is incorporated herein by reference, for a detailed discussion of an example of a hybrid chest compression device.

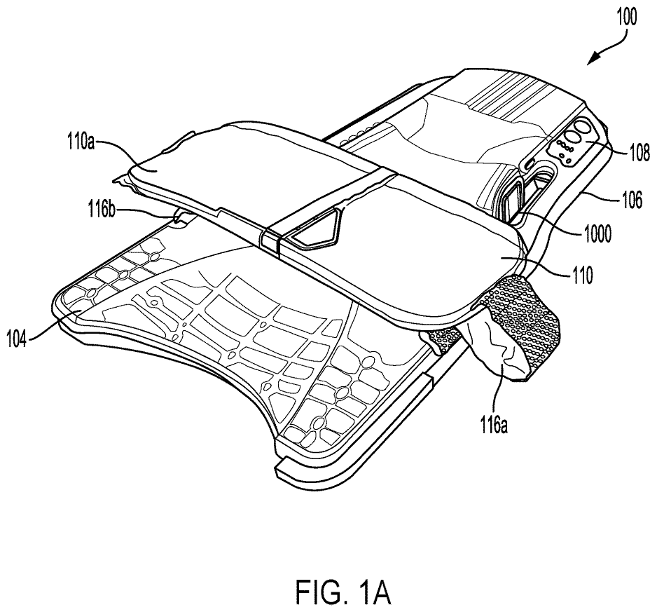

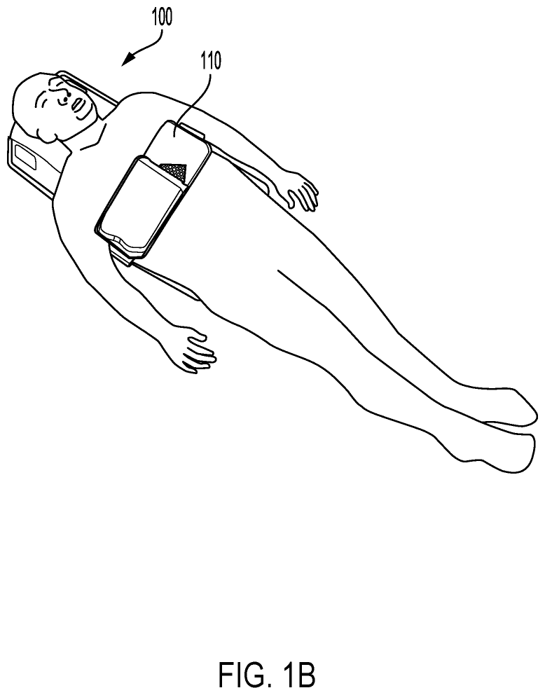

With reference to FIG. 1A, there is illustrated an example of a chest compression device 100 for performing CPR. The chest compression device 100 includes a water-resistant device or baffle 1000 in accordance with an embodiment of the present disclosure. The baffle 1000 provides improved thermal performance of the chest compression device 100 by significantly increasing cooling airflow, which, in turn, enables longer run time of the chest compression device 100 at higher ambient operating temperatures when compared to the run time of chest compression devices utilizing conventional filters. In addition, the baffle 1000 avoids complications associated with traditional mesh filters prone to clogging. The absence of filter media reduces maintenance requirements. Further, the baffle 1000 is configured to facilitate routine cleaning by a user without requiring special tools or disassembly of the baffle 1000 or the chest compression device 100. The baffle 1000 is configured to withstand stronger liquid jets, e.g., during cleaning, than conventional filters and is resistant to water splashes from any direction (IPX4 rating). Additional benefits of the baffle 1000 include ease of manufacture and fewer parts needed to assemble the device, e.g., a single fan may be used rather than multiple fans due to the improved airflow through the baffle 1000 compared to mesh filters.

The chest compression device 100 applies chest compression to a patient with a compression belt 110. The chest compression device 100 includes a platform 104 sized for placement under the thorax of the patient, upon which the patient rests during use. The platform 104 includes a housing 106 for the drive train and control system for the device. The control system, provided anywhere in the device, may include a processor and may be operable to control tightening or loosening operation of the compression belt 110 and to provide output on a user interface disposed on the housing 106. Operation of the chest compression device 100 can be initiated and adjusted by a user through a user control panel 108 and/or a display operated by the control system to provide feedback regarding the status of the chest compression device 100 to the user. The control system is configured to control the chest compression device 100 to perform repeated compression cycles when the chest compression device 100 is fitted about a patient's chest. A compression cycle includes a downstroke, an upstroke (a release portion), and delay between a downstroke and a successive upstroke, or between an upstroke and a successive downstroke.

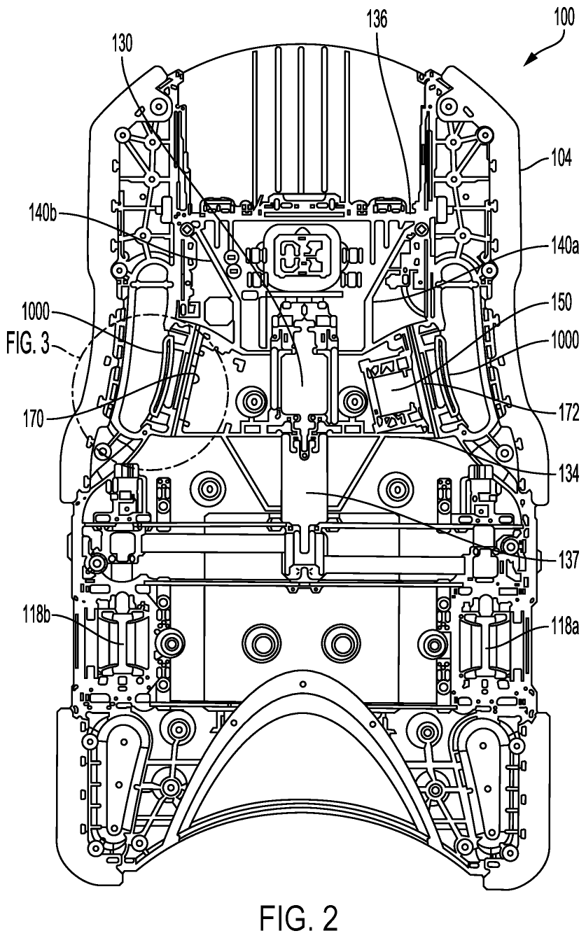

The compression belt 110 includes a wide load-distribution portion 110a at the mid-portion of the compression belt 110 and belt ends 116a, 116b, which serve as tensioning portions which extend from the load-distributing portion 110a, posteriorly relative to the patient, to drive spools within or on the housing. When fitted on a patient as shown in FIG. 1B, the load-distribution portion 110a is disposed over the anterior chest wall of the patient, and the belt ends 116a, 116b extend posteriorly over the right and left axilla of the patient to connect to their respective lateral drive spools 118a, 118b (FIG. 2).

With particular reference to FIG. 2, the drive spools 118a. 118b are disposed on respective lateral sides of the platform 104. The drive spools 118a. 1186 are in turn driven by a motor 130 disposed within the housing. The belt ends 116a, 116b are operatively coupled to the drive spools 118a, 118b such that, upon rotation of the drive spools 118a, 118b, the belt ends 116a, 116b are pulled posteriorly, spooled upon the drive spools 118a, 118b, thereby drawing the compression belt 110 towards the platform 104 to compress the chest of the patient.

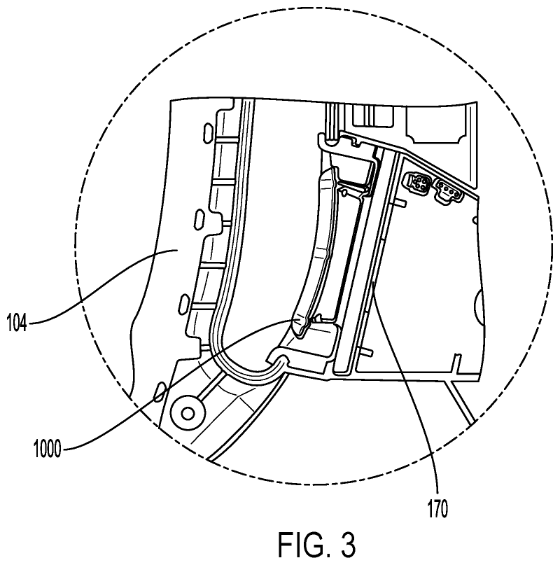

With continued reference to FIGS. 2 and 3, the platform 104 defines an exhaust aperture 170 for exhaust of cooling airflow and an intake aperture 172 for intake of cooling airflow. The exhaust aperture 170 and the intake aperture 172 are disposed at opposite sides of the platform 104. The intake aperture 172 and the exhaust aperture 170 each have a baffle 1000 associated therewith to allow airflow through the intake aperture 172 and the exhaust aperture 170, while providing liquid ingress protection. Under such a configuration, the fan 150 may be arranged to draw air through the intake aperture 172 and force air out of the exhaust aperture 170 of the platform 104 to provide forced air cooling of the heat generating components of the chest compression device 100 such as, e.g., the motor 130. In some implementations, cooling of the heat generating components such as the motor 130 may be achieved via natural convection cooling, i.e., without the use of the fan 150.

The motor 130 is disposed within a motor enclosure or compartment bounded by side walls 140a, 140b, an inferior wall 134, and a superior wall 136. The intake aperture 172 and the exhaust aperture 170 are disposed laterally of the motor 130. Under such a configuration, the baffle 1000 associated with the intake aperture 172 serves as the inlet to the motor compartment, through which, the fan 150 draws air into the motor compartment. Further, the baffle 1000 associated with the exhaust aperture 170 serves as the outlet to the motor compartment, through which, the fan 150 forces air out of the motor enclosure. Cooling airflow enters the motor compartment through the intake aperture 172 and traverses the motor 130 to provide forced air cooling to the motor 130 before exiting through the exhaust aperture 170. The improved airflow of the baffles 1000 enables use of a single fan 150 rather than having fans at respective exhaust and intake and apertures 170, 172. While it is effective to use a single fan 150, it is contemplated that a dual fan system may be utilize with one fan serving as an intake fan and the other dedicated as an exhaust fan. While the fan 150 is shown to be disposed adjacent the intake aperture 172, it is further contemplated that the fan 150 may be disposed adjacent the exhaust aperture 170. In some implementations, the above-described airflow path may be reversed, by changing the position of the fan 150. In some implementations, cooling airflow may also be directed to other components of the chest compression device 100 such as, e.g., transmission 137 (FIG. 2) by providing openings in the inferior wall 134. For example, the openings may be sized to control the distribution of airflow between the motor 130 and the transmission 137. For example, the openings may be sized to allow for greater airflow to the transmission 134 than to the motor 130 or vice versa. Alternatively, the openings may be sized to allow for equal airflow between the motor 130 and transmission 137. In some implementations, the fan 150 may be configured to provide volumetric flow rate (without restriction) of about 2 m³/min. Under the configuration of the chest compression device 100, the fan 150 may provide volumetric flow rate about 0.2-0.5 m³/min.

In certain embodiments, a baffle 1000 may be utilized in the chest compression device 100 or any electro-mechanical medical devices to allow airflow into or out of a housing of such devices to thereby cool heat generating components such as, e.g., a motor, disposed within the housing, while providing liquid ingress protection. Ingress protection (IP) testing measures the ability of device enclosures to withstand exposure to dust, water, and other solid objects. It is used to determine the level of protection that an enclosure offers against the ingress of liquids, as well as objects of varying sizes, to ensure that the device will continue to function when exposed to environmental factors. IP testing is divided into two main test categories: solid ingress testing and liquid ingress testing. All device enclosures are rated for both solid and ingress protection, which are presented in the format “IPXY”, where X is the solid ingress rating, and Y is the liquid ingress rating. For example, a device enclosure rated for IP24 implies an IP2X solid ingress rating, and an IPX4 liquid ingress rating. In some implementations, the baffle 1000 may have a liquid ingress protection rating of IPX1 to IPX4. For example, the baffle 1000 may have a liquid ingress protection rating of at least IPX4 . . . (See, e.g., TABLE 1 as provided in IP Code IEC 60529). In some implementations, the baffle 1000 may have a solid ingress protection rating of IP1X to IP4X. For example, the baffle 1000 may have a solid ingress protection rating of at least IP4X. (See, e.g., TABLE 2 as provided in IP Code IEC 60529). In some implementations, the motor may have an average power output of about 700-1000 Watts and a peak output of about 1400-3000 Watts. Such devices may have a heat dissipation requirement of about 100-300 Watts, which is achieved via airflow through the baffle 1000. In other words, such devices are capable of dissipating heat associated with about 100-300 Watts. For example, such devices may have heat dissipation requirement of about 300 Watts at about 45° C. ambient temperature. In other implementations, a baffle may have a liquid ingress protection rating of IPX1 to IPX6.

TABLE 1
Second

| characteristic | Degree of protection | |
|---|---|---|
| numeral | Brief description | Definition |
| 0 | Non-protected | — |
| 1 | Protected against vertically | Vertically falling drops shall have no |
| | falling water drops | harmful effects |
| 2 | Protected against vertically | Vertically falling drops shall have no |
| | falling water drops when | harmful effects when the enclosure is |
| | enclosure tilted up to 15° | tilted at any angle up to 15° on either |
| | | side of the vertical |
| 3 | Protected against spraying | Water sprayed at an angle up to 60° on |
| | water | either side of the vertical shall have no |
| | | harmful effects |
| 4 | Protected against splashing | Water splashed against the enclosure |
| | water | from any direction shall have no harmful |
| | | effects |
| 5 | Protected against water jets | Water projected in jets against the |
| | | enclosure from any direction shall have |
| | | no harmful effects |
| 6 | Protected against powerful | Water projected in powerful jets against |
| | water jets | the enclosure from any direction shall |
| | | have no harmful effects |

TABLE 2

| First | | |
|---|---|---|
| characteristic | Degree of protection | |
| numeral | Brief description | Definition |
| 0 | Non-protected | — |
| 1 | Protected against solid foreign | The object probe, sphere of 50 mm Ø, |
| | objects of 50 mm Ø and | shall not fully penetrate ¹⁾ |
| | greater | |
| 2 | Protected against solid foreign | The object probe, sphere of 12.5 mm Ø, |
| | objects of 12.5 mm Ø and | shall not fully penetrate ¹⁾ |
| | greater | |
| 3 | Protected against solid foreign | The object probe, sphere of 2.5 mm Ø, |
| | objects of 2.5 mm Ø and | shall not penetrate at all ¹⁾ |
| | greater | |
| 4 | Protected against solid foreign | The object probe of 1.0 mm Ø, shall not |
| | objects of 1.0 mm Ø and | penetrate at all ¹⁾ |
| | greater | |

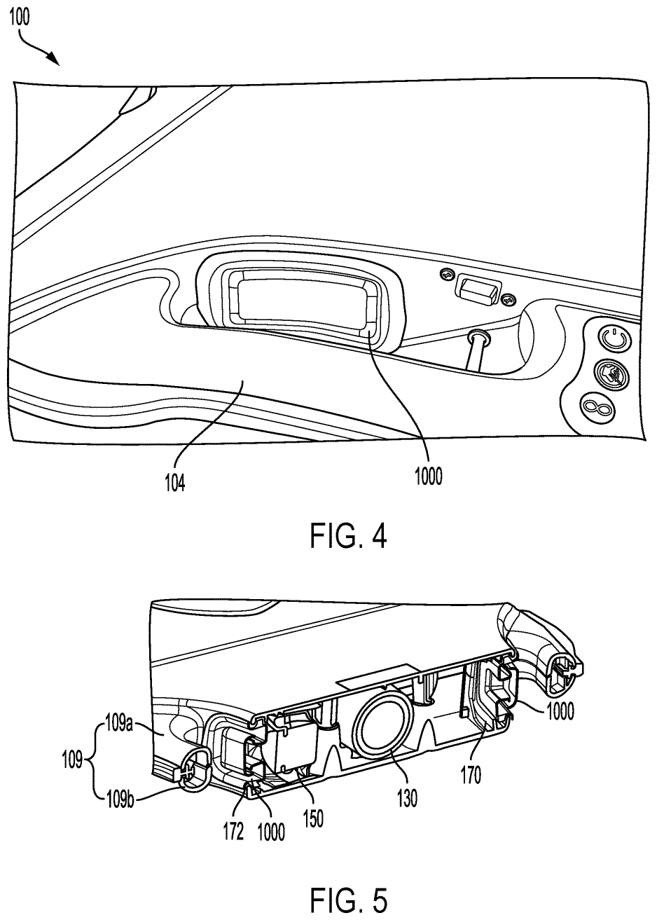

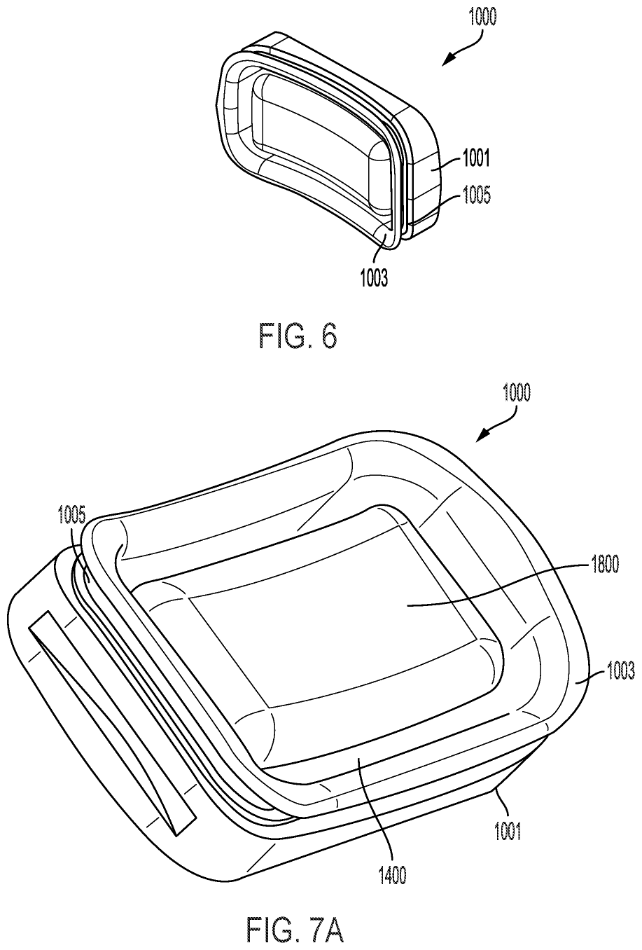

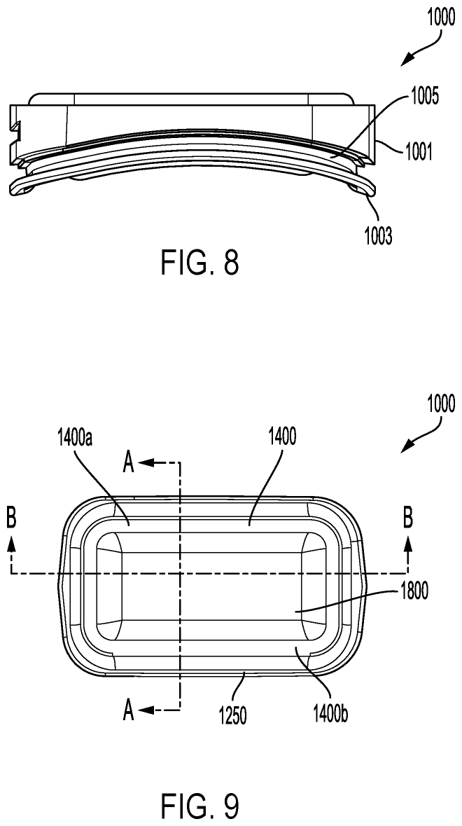

With reference to FIGS. 4 and 5, an exemplary baffle 1000 is shown. Each baffle 1000 is secured to a housing 109 of the platform 104. In particular, each baffle 1000 includes an indented portion 1005 (FIGS. 6-8) configured to receive first and second halves 109a, 109b of the housing 109 such that a first portion 1001 (FIG. 6) of the baffle 1000 is disposed within the housing 109 and a second portion 1003 (FIG. 6) of the baffle 1000 is exposed out of the housing 109. In some implementations, the indented portion 1005 may include a seal forming, e.g., a hermetic seal, against the first and second halves 109a, 109b of the housing 109.

With reference to FIGS. 9-11, the baffle 1000 includes an inner wall 1102, an outer wall 1202 spaced outwardly from the inner wall 1120, and a base wall 1302 connecting the inner wall 1102 and the outer wall 1202 and thereby defining a groove 1400 around a perimeter of the baffle 1000. The groove 1400 may define a loop having a superior portion 1400a and an inferior portion 1400b such that liquid received in the loop flows towards the inferior portion 1400b and out of the baffle 1000 by gravity, as will be described hereinbelow. The baffle 1000 further includes a flared portion 1250 configured to facilitate discharge of liquid from the groove 1400 of the baffle 1000. In some implementations, the groove 1400 may include a U-shaped cross-section. In some implementations, the superior portion 1400a and the inferior portion 1400b may be formed of hydrophobic material or may include a hydrophobic coating to facilitate flow of liquid through the groove 1400 and out of the baffle 1000.

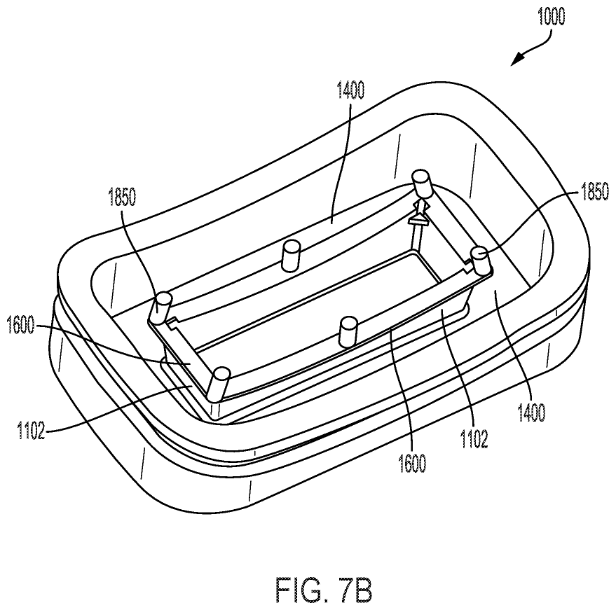

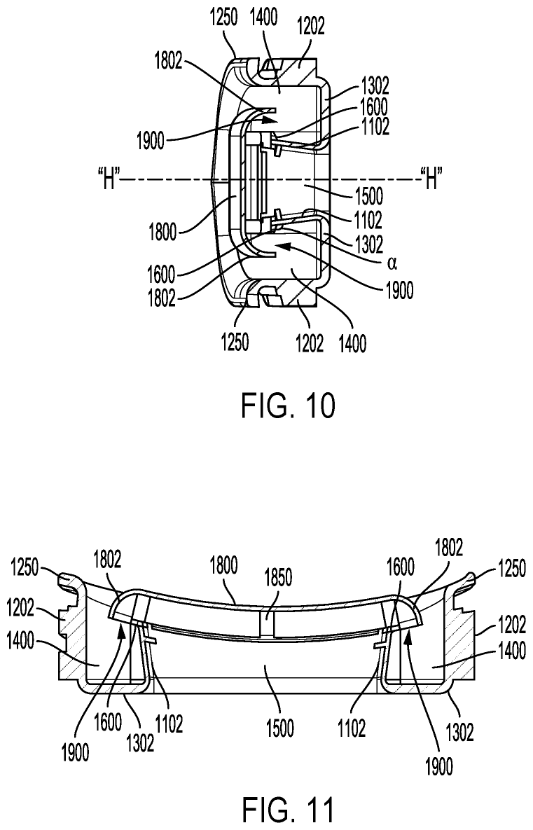

With particular reference to FIGS. 10 and 11, the baffle 1000 further defines a channel 1500 about the inner wall 1102. In particular, the channel 1500 is configured to be in communication with the corresponding intake aperture 172 (FIG. 2) or exhaust aperture 170 (FIG. 2) to enable airflow therethrough. The baffle 1000 includes a lip 1600 (as best seen in FIG. 7B) extending outwardly from the inner wall 1102 and towards the groove 1400. In some implementations, the lip may be about 2 mm. The lip 1600 is configured to help provide liquid ingress protection. The lip 1600 is dimensioned to deter liquid from flowing into the channel 1500, as will be described hereinbelow. The lip 1600 is transverse to a longitudinal axis “H-H” defined by the channel 1500. In some implementations, the lip 1600 may define an obtuse angle α with respect to the inner wall 1102. In some implementations, the inner wall 1102 may be tapered towards the corresponding exhaust aperture 170 or intake aperture 172 such that the inner wall 1102 defines an acute angle with respect to the longitudinal axis “H-H” of the channel 1500 and/or the base wall 1302. The tapered inner wall 1102 helps to provide ingress protection by directing liquid through the groove 1400 and away from the channel 1500. In some implementations, the base wall 1302 defines a plane extending in an anterior-posterior direction.

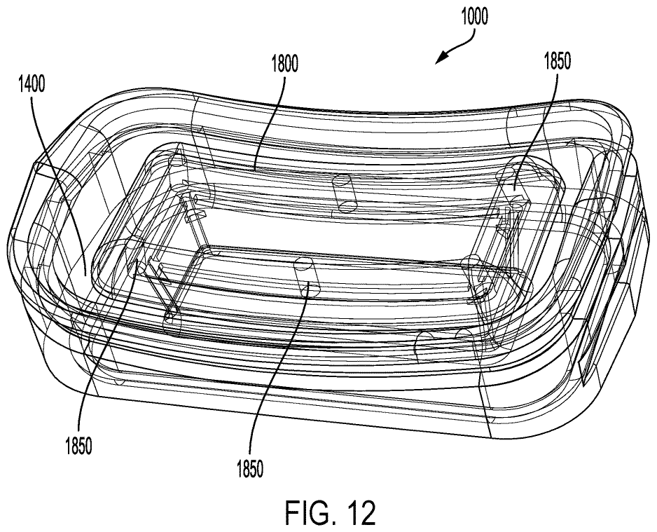

The baffle 1000 further includes a cover 1800 supported over the channel 1500. The cover 1800 is configured to deflect liquid towards the groove 1400 such that liquid flows out of the baffle 1000 through the groove 1400 by gravity, while enabling airflow through the channel 1500. The cover 1800 may include a deflecting portion 1802 extending into the groove 1400 in order to deflect liquid towards the groove 1400. In some implementations, the deflecting portion 1802 may have an arcuate profile. In some implementations, a portion of the cover 1800 may define concavity (see, e.g., FIG. 12) conforming to the contour of the platform 104 (FIG. 4). The cover 1800 is spaced apart from an opening of the channel 1500 by at least one support 1850 (FIG. 12) in order to facilitate airflow into the channel 1500. In some implementations, a plurality of supports 1850 extend from the lip 1600, as shown in FIG. 7B. In some implementations, the plurality of supports 1850 may be disposed around a perimeter of the lip 1600. As best shown in FIG. 10, the deflecting portion 1802 of the cover 1800 and the lip 1600 define a gap 1900 therebetween to enable airflow therethrough. In some implementations, the gap 900 may be about 3-5 mm.

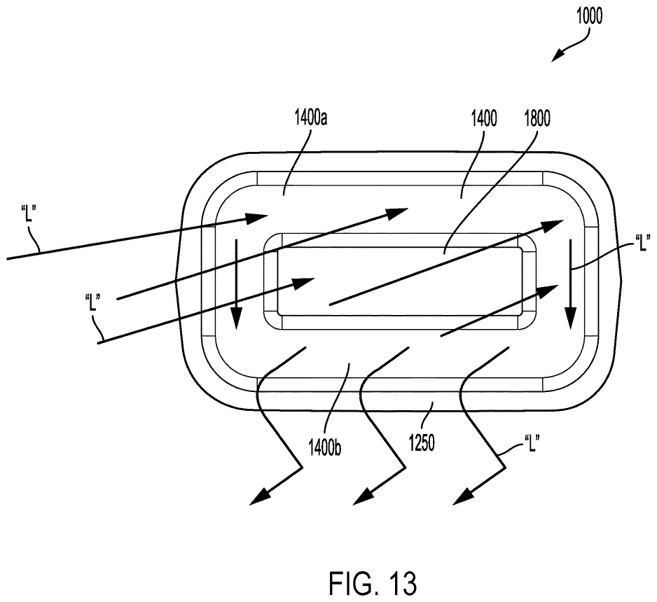

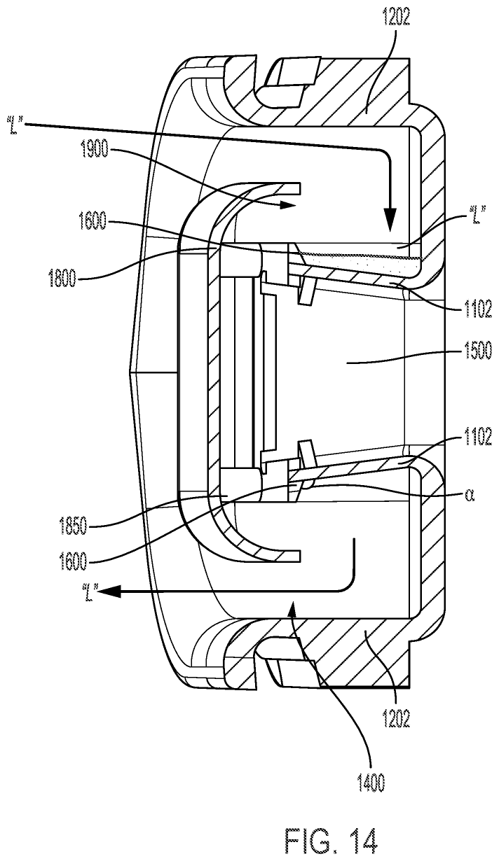

With reference now to FIGS. 13 and 14, liquid ingress protection of the baffle 1000 is illustrated. When the chest compression device 100 is exposed to liquid “L” such as, e.g., water, blood, or other bodily fluids, liquid “L” in the superior portion 1400a of the groove 1400 flows around the inner wall 1202 towards the inferior portion 1400b of the groove 1400 by gravity, and liquid “L” directed to the cover 1800 is deflected towards the inferior portion 1400b of the groove 1400 by gravity. Liquid “L” in the inferior portion 1400b is discharged from the baffle 1000 through the flared portion 1250. In particular, when liquid “L” is received in the superior portion 1400a of the groove 1400, the lip 1600 and the groove 1400 deter liquid “L” from flowing into the channel 1500, as best shown in FIG. 14.

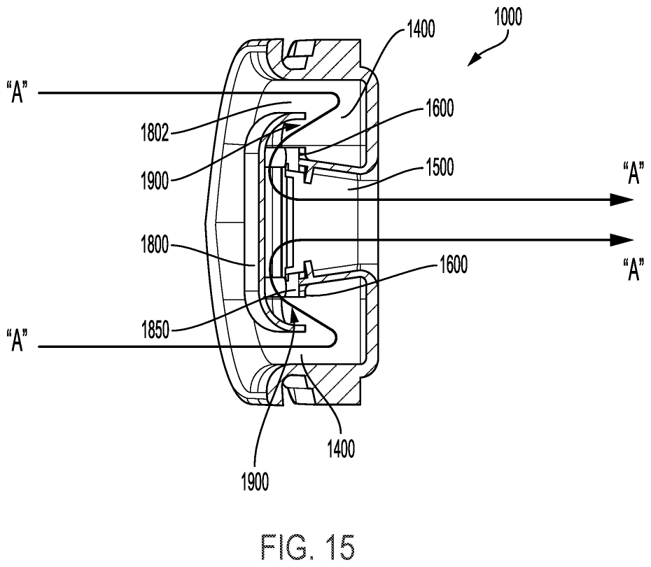

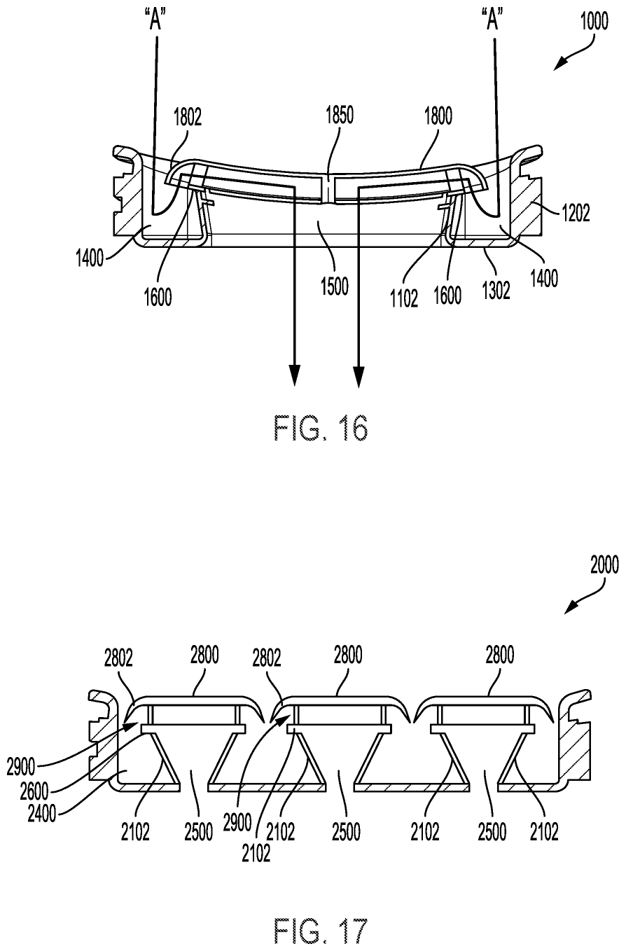

With reference to FIGS. 15 and 16, airflow path through the baffle 1000 is illustrated. Specifically, while the direction of the airflow shown in FIGS. 15 and 16 is adapted for the intake aperture 172 (FIG. 2), the baffle 1000 associated with the exhaust aperture 170 (FIG. 2) provides airflow in a direction opposite of the airflow shown in FIGS. 15 and 16. Air “A” travels through the gap 1900 defined between the lip 1600 and the deflecting portion 1802 of the cover 1800 and towards the channel 1500. Air “A” flowing through the channel 1500 is directed towards the intake aperture 172 (FIG. 2) e.g., by the fan 150 (FIG. 2). In particular, the space provided between the cover 1800 and the opening of the channel 1500 further facilitates airflow into the intake aperture 172.

With reference to FIG. 17, there is provided a baffle 2000 for use with the chest compression device 100 of FIG. 1A in accordance with another embodiment of the present disclosure. The baffle 2000 includes a plurality of channels 2500 in communication with the intake aperture 172 (FIG. 2) or the exhaust aperture 170 (FIG. 2). The baffle 2000 further includes a plurality of covers 2800 supported over the plurality of channels 2500. In certain embodiments, a single cover may extend over all of the channels 2500. Such a configuration facilitates discharge of liquid from the baffle 2000 by providing a plurality of paths for liquid to be directed to an inferior portion of the groove 2400. The baffle 2000 includes a plurality of lips 2600. Each lip 2600 extends from a corresponding inner wall 2102 to deter liquid from flowing into the corresponding channel 2500. Each cover 2800 includes a deflecting portion 2802 to deflect liquid towards the groove 2400. The deflecting portion 2802 and the corresponding lip 2600 define a gap 2900 to allow airflow therethrough. In some implementations, each inner wall 2102 and/or channel 2500 may have various shapes and profiles, e.g., conical or cylindrical. In some implementations, a baffle may include a micro-array of channels to provide additional liquid flow paths. One or more covers may extend over the micro-array of channels.

In some implementation, the cover 1800 (FIG. 7A) may be detachably coupled to, e.g., the plurality of supports 1850, as shown in FIG. 7B. In some implementations, the cover 1800 may be detachably coupled to the plurality of supports 1850 via, e.g., snap-fit or friction fit configurations. Such a configuration may facilitate cleaning of the baffle 1000.

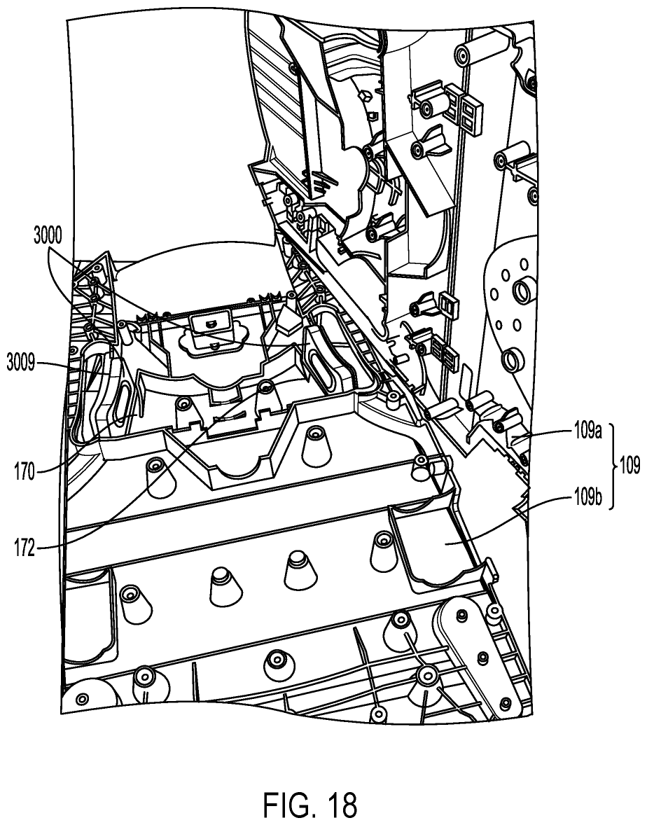

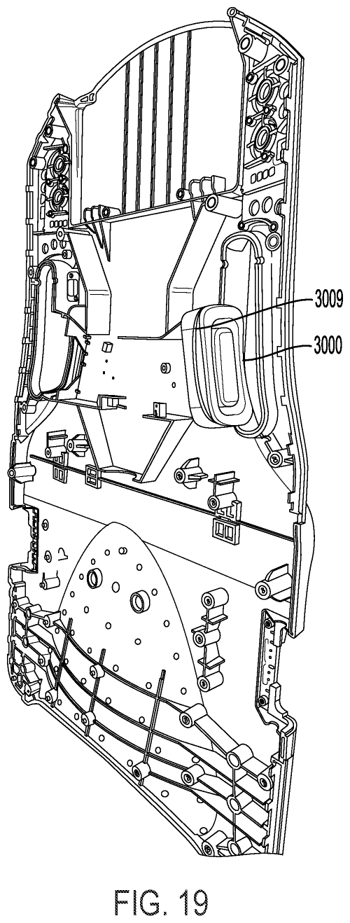

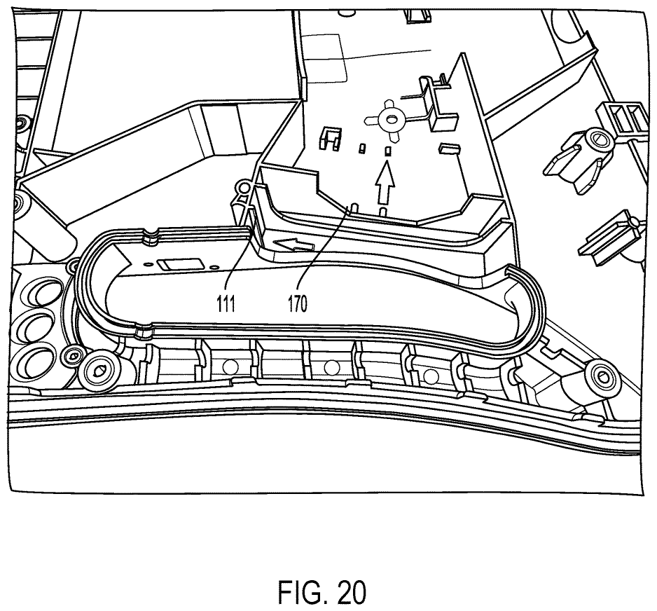

With reference to FIGS. 18-20, the housing 109 of the platform 104 (FIG. 4) is shown. The housing 109 includes the first and second halves 109a, 109b. Baffles 3000 may be disposed at respective intake and exhaust apertures 170, 172. Each baffle 3000 may include a seal that 3009 that forms, e.g., a hermetic seal, against the first and second halves 109a, 109b of the housing 109. The first and second halves 109a, 109b of the housing 109 may include an alignment guide 111 (FIG. 20) configured to be received in an alignment groove defined in the baffle 3000 to facilitate alignment and securement of the baffle 3000 to the housing 109. In some implementations, the baffles 1000, 2000, 3000 may be molded as a single construct. In some implementations, the baffles 1000, 2000, 3000 may be monolithically formed as a single construct. In some implementations, the baffles 1000, 2000, 3000 (FIG. 12) may have concavity conforming to the contour of the platform 104 (FIG. 4). In some implementations the housing 190 may be made from a material having a low thermal conductivity, thereby further reducing the risk of injuring the patient due to overheating.

In certain implementations, a baffle, filter or other liquid resistant device that provides the ingress protection and allows for airflow to dissipate heat in accordance with the requirements described herein may be utilized instead of or in combination with the various embodiments described herein.

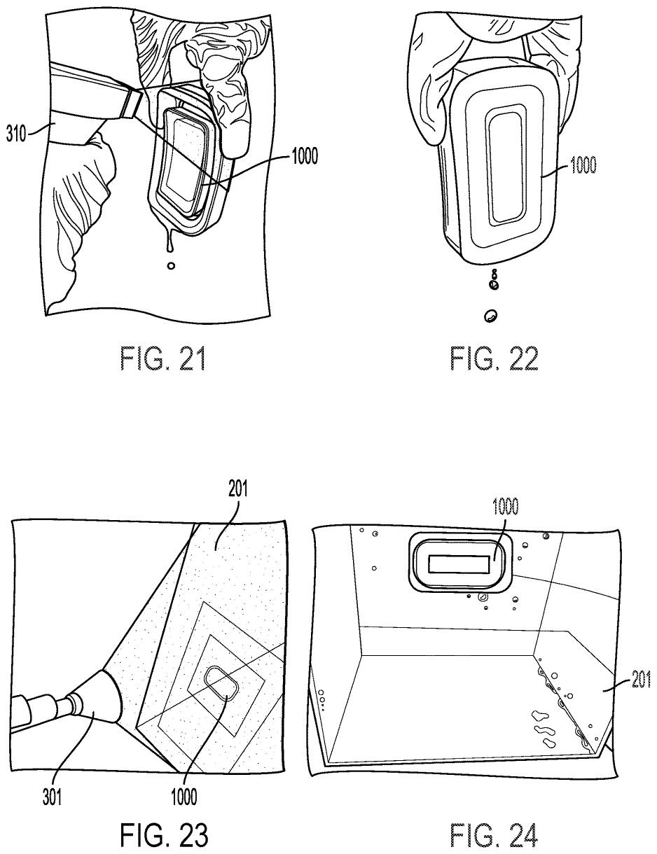

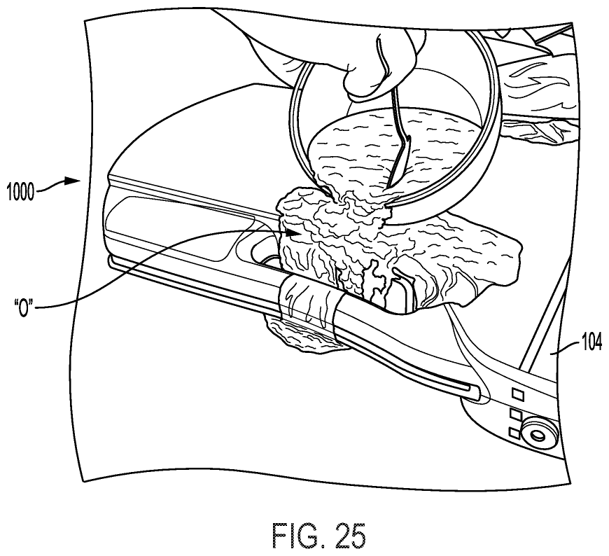

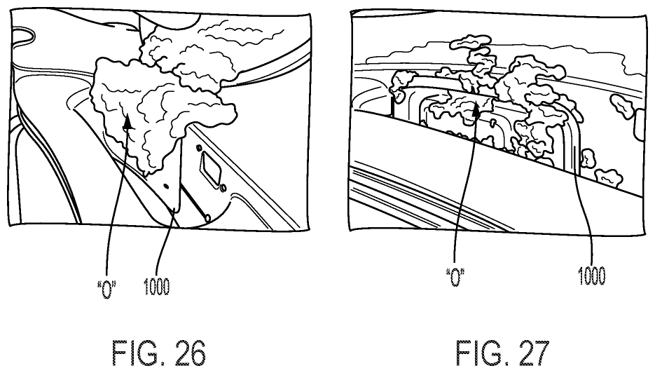

With reference to FIGS. 21 and 22, testing of the baffle's ability to provide liquid ingress protection was performed. The baffle 1000 was first sprayed with water from a spray bottle 310 at various angles to observe penetration of liquid into the channel 1500 (FIG. 16). It was observed that the channel 1500 remained dry throughout the testing process. With reference to FIGS. 23 and 24, the baffle 1000 was mounted on a transparent cube 201 in a manner similar to the platform 104 (FIG. 2). The testing parameters conformed to the specification for IPX4 testing. In particular, the water was sprayed at a rate of about 10 liters/min for about 5 minutes from a distance of about 12 inches (about 300 mm). The water was sprayed from different angles using a IPX4 compliant nozzle. The channel 1500 of the baffle 1000 and the transparent cube 201 remained dry throughout the testing process. With reference to FIGS. 25-27, the baffle 1000 was further tested with oatmeal “O” to determine cleanability of the baffle 1000 to replicate human waste or bodily fluids. After letting the oatmeal dry for about 30 minutes, the baffle 1000 was cleaned using water. Solids deposited on the baffle 1000 were wiped clean using damp paper towel/cloth and a cotton swab, while maintaining liquid ingress protection. The inner portions of the baffle 1000 such as the groove 1400 were cleaned using the cotton swab and bristle/foam brushes.

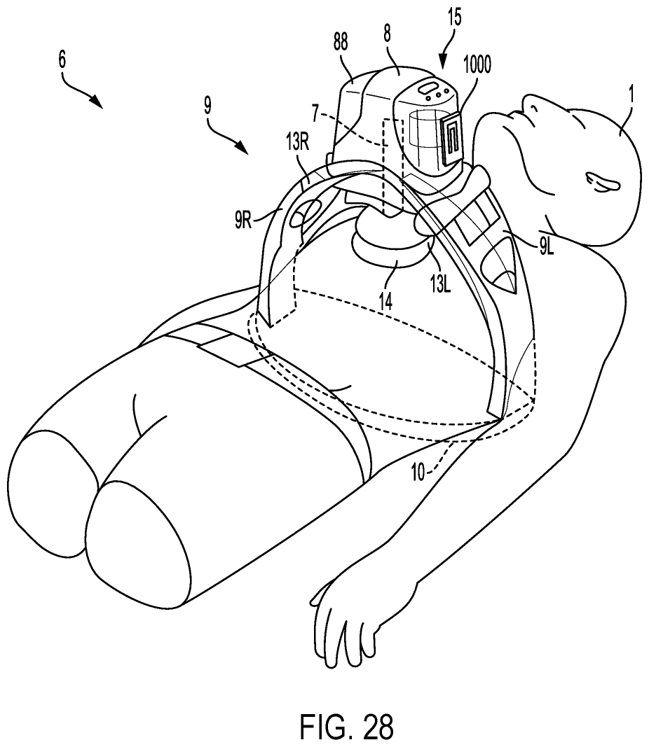

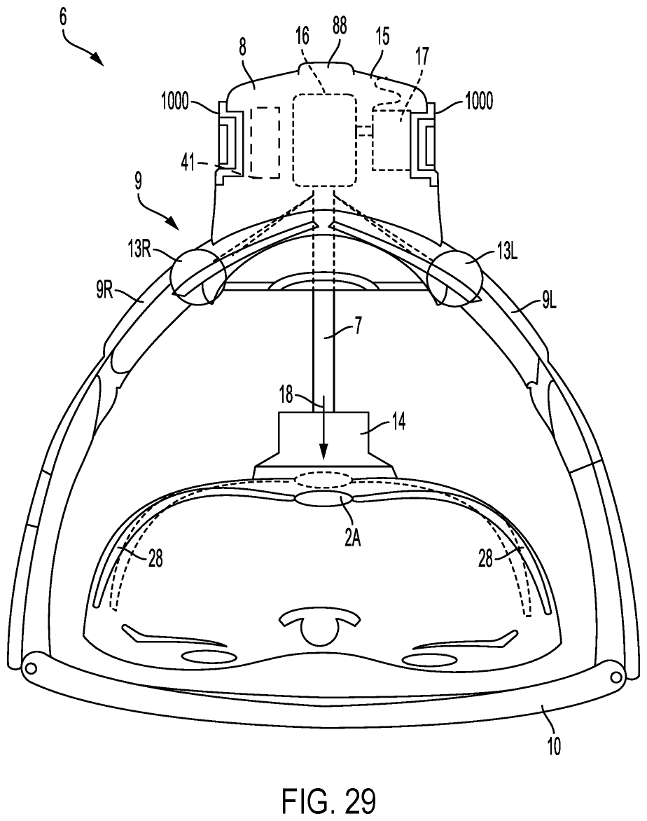

Though the features provided for providing cooling airflow to beat generating components of a chest compression device have been described in the context of belt-driven CPR chest compression devices, such features may be incorporated into other CPR chest compression devices, such as piston-based chest compression devices and hybrid systems using both piston actuators and compression belts and various ACD devices. FIGS. 28 and 29 illustrate a piston-based chest compression device 6. The piston-based chest compression device 6 applies compressions with the piston 7. The piston 7 is disposed within a compression unit 88 which is supported over the patient with a frame or gantry 9 having two legs 9L and 9R fixed to a backboard 10. Compression unit 8 is connected to legs 9L and 9R at hinges 13R and 13L. When disposed about the patient, the frame extends over the thorax of the patient so that the piston 7 is disposed apposing the sternum to contact the patient's chest directly over the sternum, to impart compressive force on the sternum of the patient as shown in FIG. 29. The piston 7 may include a removable compression pad 14 adapted to contact the patient's chest. The chest compression device 6 is controlled using a controller 17 which is operated by a rescuer through an interface 15, which may include a display to provide instructions and prompts to a rescuer and includes an input device to accept operating instructions from the rescuer.

As illustrated in FIG. 29, the compression unit 88 is enclosed by the housing 8. The piston 7 is driven, either directly or indirectly, by a motor 16 under control of the controller 17 to extend and retract the piston 7. The controller 17 may include one or more microprocessors. Cyclic extension and retraction of the piston 7 causes cyclic exertion of compressive force 18 to the patient's sternum 2A. The controller 17 actuates and controls operation of the motor 16 and other elements or components of the chest compression device 6. The controller 17 may include one or more sets of instructions, procedures or algorithms to control actuation and operation of the motor 16 and other elements or components of the device 6.

The housing 8 of the compression unit 88 includes the baffles 1000 mounted thereon. The housing 8 defines an intake aperture and an exhaust aperture on opposite sides of the housing 8 to provide cooling airflow therebetween. The housing 8 is further provided with a fan 41 within the housing 8 to draw air through the intake aperture and force air out of the exhaust aperture. The baffles 1000 and the fan 41 are positioned to direct cooling airflow through the heat generating components such as the motor 16, the controller 17, the piston 7, or the interface 15. The baffles 1000 provide improved airflow through the housing 8, while providing liquid ingress protection. Use and operation of the baffles 1000 mounted on the housing 8 is substantially similar to the use and operation of the baffles 1000 described hereinabove with respect to the chest compression device 100.

A number of implementations have been described. For example, the detailed description and the accompanying drawings to which it refers are intended to describe some, but not necessarily all, examples or embodiments of the system. The described embodiments are to be considered in all respects only as illustrative and not restrictive. Nevertheless, it will be understood that various modifications may be made without departing from the spirit and scope of the data processing system described herein. Accordingly, other embodiments are within the scope of the following claims.

1. A system for performing chest compressions on a patient comprising:
an actuation assembly configured to provide chest compressions on the patient;
a platform configured to support the patient during chest compressions, the platform enclosing the actuation assembly, wherein the platform defines an intake aperture configured for intake of cooling airflow and an exhaust aperture configured for exhaust of cooling airflow; and
at least one baffle disposed at the intake aperture or the exhaust aperture, the at least one baffle comprising:
a channel in communication with the intake aperture or the exhaust aperture;
a groove formed around a perimeter of the at least one baffle, wherein the groove is configured to direct liquid out of the at least one baffle; and
a cover disposed over the channel and configured to deflect liquid towards the groove, wherein the groove and the cover provide protection against liquid ingress into the channel while allowing airflow into the channel.

2. The system according to claim 1, wherein the groove is configured to direct liquid out of the at least one baffle by gravity.

3. The system according to claim 2, wherein the groove defines a loop including a superior portion and an inferior portion such that liquid received in the loop flows towards the inferior portion and out of the at least one baffle by gravity.

4. The system according to claim 3, wherein the at least one baffle further includes a lip configured to inhibit flow of liquid into the channel.

5. The system according to claim 4, wherein the lip extends towards the groove.

6. The system according to claim 4, wherein the lip and the cover define a gap therebetween to allow airflow into the channel.

7. The system according to claim 1, wherein the at least one baffle includes a flared portion configured to facilitate flow of liquid out of the groove of the at least one baffle.

8. The system according to claim 6, wherein the cover includes a deflected portion extending into the groove.

9. The system according to claim 8, wherein the deflected portion has an arcuate profile.

10. The system according to claim 6, wherein the cover defines a concavity.

11. The system according to claim 4, wherein the cover is spaced apart from an opening of the channel by at least one support.

12. The system according to claim 11, wherein the channel defines a longitudinal axis, the lip is transverse to the longitudinal axis.

13. The system according to claim 1, wherein the at least one baffle is formed of a hydrophobic material.

14. The system according to claim 1, wherein the at least one baffle is molded as a single construct.

15. The system according to claim 14, wherein the at least one baffle is monolithically formed as a single construct.

16. The system according to claim 1, wherein the at least one baffle has a seal hermetically sealing against first and second halves of the platform.

17. The system according to claim 1, wherein the groove has a U-shaped cross-section.

18. The system according to claim 1, further comprising a fan disposed within the platform, the fan being arranged to draw air through the intake aperture and force air out of the exhaust aperture of the platform.

19-59. (canceled)

60. The system according to claim 1, wherein the actuation assembly comprises a motor, and the airflow acts to cool the motor.

61. The system according to claim 1, further comprising an actuator configured to provide compression and/or decompression on a patient.

62. The system according to claim 16, wherein the actuator is a belt or a piston.

63. The system according to claim 1, wherein the cooling is performed by natural convection cooling.
